(19) United States
(12) Patent Application Publication
(10) Pub. No.: US 2011/0282773 A1
(43) Pub. Date: Nov. 17, 2011

(54) Method For Sequestering Carbon Dioxide Via Fertilization Of A Body Of Water From The Air, And For Acquiring Compensation Therefrom

(76) Inventor: Leslie Morgan Gray, III, Bristol, RI (US)

(21) Appl. No.: 12/779,473

(22) Filed: May 13, 2010

(51) Int. Cl. G06Q 99/00; G06Q 40/00; G06Q 90/00

(52) U.S. Cl. 705/37; 705/500; 705/1.1

(57) ABSTRACT

A method of sequestering carbon dioxide in a body of water such as an area of ocean by seeding the water surface with a fertilizer including iron. The seeding is conducted from the air using an aircraft equipped with a device to record or otherwise document the details of the iron distribution, where the method of distribution has been approved in advance for acquisition of carbon sequestration credits by an appropriate agency. Evidence of the success of the application is presented to the appropriate regulatory body and the carbon credits acquired.

### TECHNICAL FIELD

The invention relates to sequestering carbon by fertilizing a body of water, e.g., to enhance ocean plankton photosynthesis, to methods for efficient stimulation by fertilizing with iron, and to methods for accounting and monetizing the sequestration.

### BACKGROUND

One way to reduce the buildup of carbon dioxide in the atmosphere is to sequester carbon in a manner to remove it from the atmosphere, and lock it up for a significant period of time (e.g. plant a forest). This is called carbon sequestration, and is currently the subject of the world's “carbon trading markets”, whereby credits for carbon sequestration are purchased by carbon polluters, as offsets. This market-based approach to carbon sequestration is large and growing.

One carbon sequestration technique is Ocean Iron Fertilization (OIF)—(see refs 1,2). There have been several scientific experiments conducted to date by various world organizations, which have demonstrated the efficacy of the effect. This work in documented, for example in references 1 and 2 which are incorporated in this application by reference.

OIF is based on the recognition that some areas of the ocean are deficient in iron, but have sufficient other nutrients to support life—so called high nutrient low chlorophyll (HNLC) areas—which are well documented (ref 1). In these HNLC areas, the growth of photo plankton is limited by this scarcity of iron, and it has been shown that introducing iron in the proper form and via a proper method can cause significant growth of plankton, some of which eventually is sequestered in the deep ocean through a variety of mechanisms.

The amount of iron needed for effective fertilization is very small. Ideally, this iron is introduced in a manner that spreads it uniformly across the surface, in a form that persists in the upper photic ocean layer (doesn't sink). Also, the biological response to the fertilization should happen quickly, to aid in tracking the plankton bloom for validation of sequestration.

There are various mechanisms to encourage carbon sequestration. In one mechanism carbon credits may be issued by an agency, such as a government agency, an international agency, a private agency, or an agency with aspects of one or more of the above. The agency is authorized to provide carbon credits to entities that can establish that they (or their agents) have engaged in activities that sequester carbon. Such activities can be prescribed in advance, and can include enhancing photosynthesis on land or sea.

The carbon credits can be in any form that has value to the entities who have engaged in such activities. In addition to direct monetary payment, the credits can include tax benefits or other valuable credits that the agency is authorized to provide. Any other monitizable form of providing a valuable right to the entity that sequesters carbon can be used.

### SUMMARY

In one aspect the invention features methods of acquiring a monitizable credit to be provided to entities which sequester carbon. The credits are provided by any agency authorized to issue the credit for distributing a plankton-growth fertilizer to a body of water. In particular, the agency provides carbon credits to entities that provide verification of distribution of a plankton growth fertilizer including iron to a body of water. The entity provides evidence to the agency of successful fertilization and carbon sequestration by delivery of the fertilizer to a body of water from the air, and the agency then provides the entity a monitizable credit for carbon sequestration.

In a second aspect, the invention features outfitting an aircraft to distribute a plankton-growth fertilizer, by providing on the aircraft:

a composition that is, or can be used to make, a fertilizer for application to a body of water, the composition including iron in a form that is, or can be converted into, a biologically useful form usable for fertilization,

an apparatus for dispersing the dispersal of the fertilizer from the aircraft,

an apparatus for monitoring the dispersal of the fertilizer to a body of water, and

an apparatus for verifying that the fertilizer has been applied to a body of water.

It is a particular feature of the invention that the data described herein may be stored on computers, read by computers, and transmitted in computer-readable formats. Computers can enhance security through the use of well-known means of preventing, or at least recording, alteration of the data so stored. For example the data may be stored on remote servers that are secure. The data may be retrieved and displayed on a computer monitor. The agency authorized to issue credits may impose such requirements.

In preferred embodiments, the fertilizer comprises chelated iron sulfate. Alternatively the iron is included in a Metal Organic Framework (MOF). For example one or more iron ions are stably caged within an organic molecule. The apparatus for monitoring dispersion of the fertilizer from the air is an apparatus that can collect and store data regarding the distribution rate of the fertilizer, aircraft location, aircraft elevation, and aircraft speed. These data are or can be converted to a form to be presented to the agency to validate that the application of fertilizer took place in a manner approved by the agency. The various apparatus outfitted on the aircraft—e.g., the apparatus for monitoring dispersal, the apparatus for dispersing and the apparatus for verifying dispersal—may be present as one device or as separate devices.

Also in preferred embodiments, the aircraft includes apparatus for collecting data representing local wind and data representing local water current and these data are integrated with the apparatus and algorithm for controlling dispersion of the fertilizer. The apparatus for verifying application of fertilizer includes apparatus to receive signals from buoys that indicate the presence of iron or trace elements distributed on the ocean surface, and/or apparatus for determining the presence or concentration of plankton. The apparatus for monitoring the dispersal of fertilizer may include apparatus for receiving and processing signals from buoys, floating with the currents, which communicate a location on the surface water, and to provide a signal for adjusting one or more of the aircraft's operating parameters, including course, speed, or altitude for optimum fertilizer dispersal in the presence of a current.

The aircraft is provided with means to control the aircraft to disperse the fertilizer in a controlled pattern designed for uniformity of distribution of the iron fertilizer on the surface of the ocean. While any pattern (perpendicular, parallel or in between) may provide an effect, it is preferable that the pattern may be oriented roughly perpendicular to the local wind direction. The pattern preferably may be within (+/−) 60 degrees of perpendicular, and is more preferably within 30 degrees of perpendicular. The pattern preferably includes dispersal as the aircraft is flown at varying elevations, and it includes dispersal at lower elevations at the edges of the pattern, for ease of validation of the plankton bloom. Also preferably, the pattern of dispersal may include overlapping tracks.

The credit for carbon sequestration is payment from a registered carbon trading market. It may be a direct payment for services (e.g. in the form of an electronic payment), and the agency is a governmental agency or a corporate entity. The credit may also be authorization for a tax benefit from a governmental agency or taxing authority. Alternatively the credit may be authorization to emit carbon dioxide to the atmosphere. The actual seeding is conducted in the open ocean, outside the jurisdiction of any particular country.

In order to acquire carbon credits in a particular carbon market, a project must first be proposed and approved by an agent for that market. As part of this project approval, the proposed evidence of the actual dispersion of the iron and evidence of the plankton bloom effect, and evidence of sequestration, has to be presented to the appropriate regulatory or approval agency.

This evidence will have two forms, the first being evidence that the iron was actually distributed from the aircraft according to the approved plan, and the second that the growth of plankton was actually seen in the ocean. The first form of this documentation will require a device to meter the amount of iron distributed per unit time, along with documentation of the location of the aircraft, the elevation, and the date and time of application. Alternative or additional documentation includes measurements of iron levels in the water and/or measurements of plankton to which can be compared before and after seeding. This information will have to be recorded in a way that is immune to falsification.

The second form of this documentation will involve some methods and processes that are not a subject of this invention (such as local sensing with buoys or sediment traps or underwater vehicles, and/or remote sensing from space based satellites. Such sensing can directly or indirectly provide evidence as described above.

The efficacy of the result of air-based fertilization is very much influenced by the pattern flown for distribution of the iron. Since the iron fertilizer carrying capacity of the aircraft is the limiting factor in its ability to seed, the effectiveness of the pattern, and the elimination of the high “overkill ratio” of iron, as is used from shipboard is necessary for low cost and high effectiveness.

In order to obtain this efficient mixing and distribution, it is also an advantage to distribute the iron roughly perpendicular to the prevailing surface winds. This allows the to pattern of iron to precipitate and be born “downwind” to cover the surface more lightly (FIG. 5). The optimum pattern to be flown is a function of the local winds, the precise form of iron used, the details of the dispersal medium (dry or wet), the details of the distribution nozzle, the actual distribution rate, the degree of overlap desired, and the “overkill ratio” planned to cover uncertainties. These details may be part of the application to, and the validation requirements of, the regulatory body.

For accurate validation, the seeded pattern preferably should include a clear definition of the edges of the seeded ocean area. Uncertainty in this definition will decrease the value of the carbon credits. To minimize this uncertainty, the pattern of distribution may be modified, such that the elevation of the seeding aircraft at the edges of the pattern is lower, and hence the uncertainty of the location of the iron on the ocean is also lower (see FIG. 3, 4). Inside the pattern, away from the edges, it is an advantage to distribute the iron from higher elevations, and allow mixing from different distribution tracks. In fact, overlapping tracks is an effective way to reduce the non-uniformity of the iron distribution. In practice, the monitoring of effective distribution may involve the use of additional sensors that will sense the presence of trace elements mixed with the iron fertilizer.

Finally, the iron can be in several forms. All tests to date have used a form of iron, which is chelated by mixing iron sulfate with hydrochloric acid. The iron sulfate is mixed with the acid and forms slurry, which may be further mixed with seawater and pumped overboard from a ship or floating vessel. This is also an acceptable approach for distribution from an aircraft, although the amount of water needed for effective handling can limit the amount of iron carried on each flight, increasing the cost per unit ocean area of the seeding.

As second method of distributing the iron involves forming iron into a metal organic framework (MOF). In this form, the iron is bound as a molecule with molecules of carbon, in a framework that may be especially suited for ocean iron fertilization. The advantage of a MOF form is that the iron may be in a dry powder or pelletized form, especially suited for low surface density distribution from an aircraft. In a MOF form, the molecule may also include trace elements for ease in detection, and other features, such as might affect the density or the time for dissolving. In the preferred form, the MOF will have a density very close to that of seawater, so that it does not sink below the photic layer, but rather persist in the upper ocean layer where it can be available to the life forms.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a typical pattern for the distribution of iron fertilizer from the air, which would be appropriate if there were no ocean currents. The track spacing is set based on the elevation of the aircraft, the rate of distribution of the fertilizer, and the local winds. The best pattern is to fly roughly perpendicular to the prevailing winds. One of the limits to this pattern is the ability of the aircraft to turn within the proscribed track spacing.

FIG. 2 shows a more realistic pattern, which allows a more leisurely turning, or track spacing closer than the aircraft turning radius.

FIG. 3 shows a pattern where the spacing of the tracks at the edges of the pattern is tighter (and the aircraft would be at a lower elevation). This is done to have better definition of the edges for remote tracking.

FIG. 4 shows a pattern where the track is adjusted for the ocean currents. In this example, ocean buoys are at 4 points, and as the aircraft flies from buoy 1 to 4, the current takes the buoys down current a distance related to strength of the current. In this example, the track is adjusted to keep a fixed distance down current from the reference buoy.

FIG. 5 shows a typical distribution of fertilizer, as influenced by the surrounding winds. The fertilizer is distributed downwind a distance from the track, which is a function of the wind velocity, the elevation of the aircraft, and the particulate size, mass, and form factor.

FIG. 6 shows how the distribution by aircraft can yield a fairly uniform distribution of fertilizer on the ocean surface. This compares very favorably to a ship based distribution, where all of the fertilizer is applied in a very small (<100 Meter) strip, centered 2,500 meters or more apart, where the hope is that horizontal mixing will “even out”.

FIG. 7 shows an aircraft outfitted with an essentially dry fertilizer composition, an apparatus for dispersing the fertilizer from the aircraft, an apparatus for monitoring the dispersal of the fertilizer to a body of water, and an apparatus for verifying that the fertilizer has been applied to a body of water.

FIG. 8 shows an arrangement of equipment, which may be located exclusively on an aircraft, located on a combination of an aircraft and a surface vessel, or located remotely (on land) and connected through wireless or satellite communication devices; where the data from the on-aircraft dispersal system is combined with other data from the aircraft, from buoys and/or from other reference sensors, in a data storage device which is necessary for validation that the dispersal process took place as proposed to the regulatory body.

### DETAILED DESCRIPTION

The subject of the invention is the acquisition of validated carbon credits, obtained via the ocean iron fertilization process, which includes the spreading of the iron from the air.

The essential problem that has to be solved is that only a very small amount of iron that is needed per unit ocean surface area. Estimates of the maximum amount or iron that can be effectively used by the plankton is on the order of 3.3 kg/km̂2 (˜0.50 oz/acre). Thus an effective fertilization process will be one where the iron can be lightly and uniformly distributed over the surface of the ocean.

One of the large disadvantages of a ship-based distribution of iron is that the vessel cannot easily distribute the iron perpendicular to the vessel track. In order to distribute the iron, the vessel has to effectively “mow the ocean”—following a pattern of track spacings that are fairly close together (e.g. 2-5 km), especially relative to the size of the area to be fertilized. Because the ship has no real ability to distribute the fertilizer very far from the vessel track, the process must rely on the “hope” of natural transverse spreading to distribute the fertilizer perpendicular to the vessel's track. In practice, this transverse spreading is very inefficient, and it must happen before the fertilizer sinks below the photic layer. To counter this horizontal spreading uncertainty, ship based spreading efforts often use an “overkill ratio”—spreading much more fertilizer than biologically necessary (up to 20×). This uncertainty of application makes it difficult to precisely measure or predict the amount of biological life generated, as sampling from fixed points may not be representative of the entire fertilized area.

Another issue that is unique to ocean spreading is the existence of significant ocean currents. In the areas of interest, ocean currents may be on the order of as much as 10 Km/hr. This is a significant source of uncertainty, especially for ship-based seeding approaches. The presence of these ocean currents, which may be significant relative to the ship speed, makes the actual ship tracks very difficult to determine, resulting in a high likelihood of under or over fertilization.

Thus, there are two significant advantages of air-based seeding—the elevation of the distribution source assures a more even distribution over the ocean surface, the elevation can increase the track spacing significantly, and the speed of the aircraft is less affected by ocean waves or currents than a ship based approach.

Properly done, with the correct form of iron, one aircraft can carry and spread sufficient iron (˜30 tons) to properly fertilize a 100 km×100 km patch, and distribute it in one mission (˜12 hours). This allows the iron to be distributed quickly, in an available “weather window”, with proper uniformity

One way to address the uncertainty caused by ocean currents is to have an airspeed that is large relative to the track spacing. For example, with a 100 km track, and a 400 km/hr air speed, the turn-around uncertainty to the starting point is roughly 4 km. This is still very large, as the track spacing may be on the order of 5-10 km. However, knowing the local currents, this error may be approximated, and the track corrected for the effects of ocean currents.

A second way to address this uncertainty is to employ a number of reference buoys, which will float with the current. These buoys would be dropped at known points in the seeded area, and used to calculate the optimum spreading pattern. The use of these buoys to assist the spreading accuracy is one of the subjects of the invention. These buoys may also have sensors that will detect the presence of iron, or other trace elements, which are added to the fertilizer to validate distribution effectiveness.

In order to spread the iron effectively, and to document the process for eventual acquisition of carbon credits, the aircraft will need a device to mix, meter, and spray the iron. This device will measure (at a minimum) location, elevation, air speed, and spray rate. Other information may also be included and logged (e.g. weather and current data, sensor or buoy data). The data logging and the device will be secure from tampering or false entries. This device will be located onboard the aircraft. The device may be a collection of separate devices that together affect the same purpose. The information provided by this device is used to validate the seeding actually took place as planned, for the purpose of acquiring the carbon credits.

The material used for fertilization may be chelated iron sulfate and water, which while not particularly suited for air seeding due to the amount of water that must be included, is the current standard (see ref 9). The iron also may be in a form of a Metal Organic Framework (MOF), wherein the iron is bonded with carbon and other elements to provide a framework with specific features. These features may include a density that keeps the MOF in the upper surface of the water column, a dissolution rate that allows for a “time release” of the iron over a period of time (e.g a few days to a few months), and the inclusion of trace elements for ease in tracking the iron. This MOF framework yields a very small particle size, with a lot of surface area, allowing the iron to be available to the plankton in the proper form. The size of these particles may be on the order of <0.1 mm, lower than the range specified in (ref 5). In addition, the aspect ratio of these MOFs is significantly less than the 1/10, as specified in (ref 5)

The actual seeding of the iron, in whatever form, has to respect the environmental conditions at the place of seeding, to assure both uniform distribution, and to maximize the efficiency and minimize the cost (because of the limitations of carrying capacity and finite duration of the aircraft mission). Much like the ship-based spreading optimized spreading pattern, (ref 8), there are optimum patterns for this air-based dispersal.

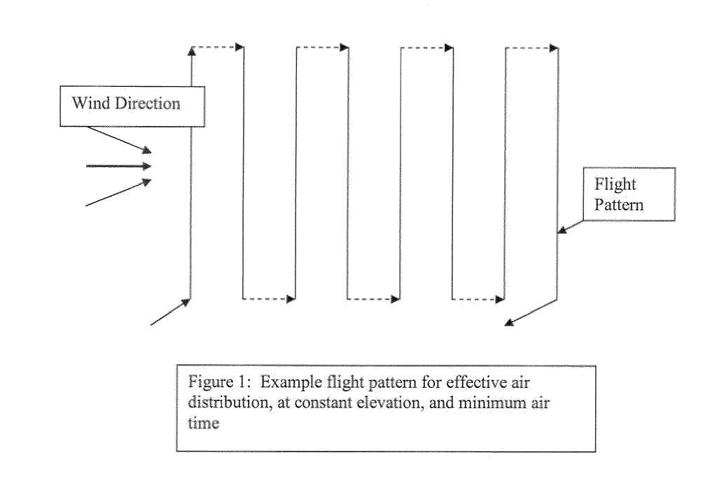

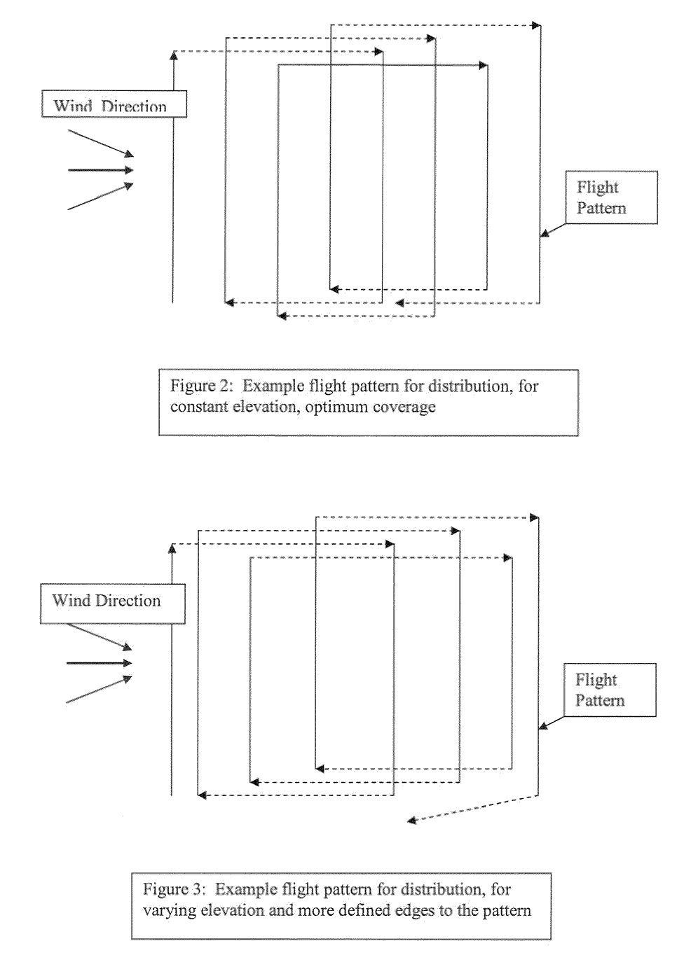

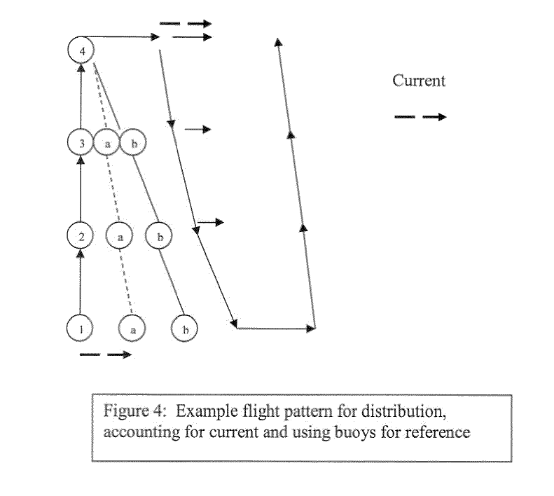

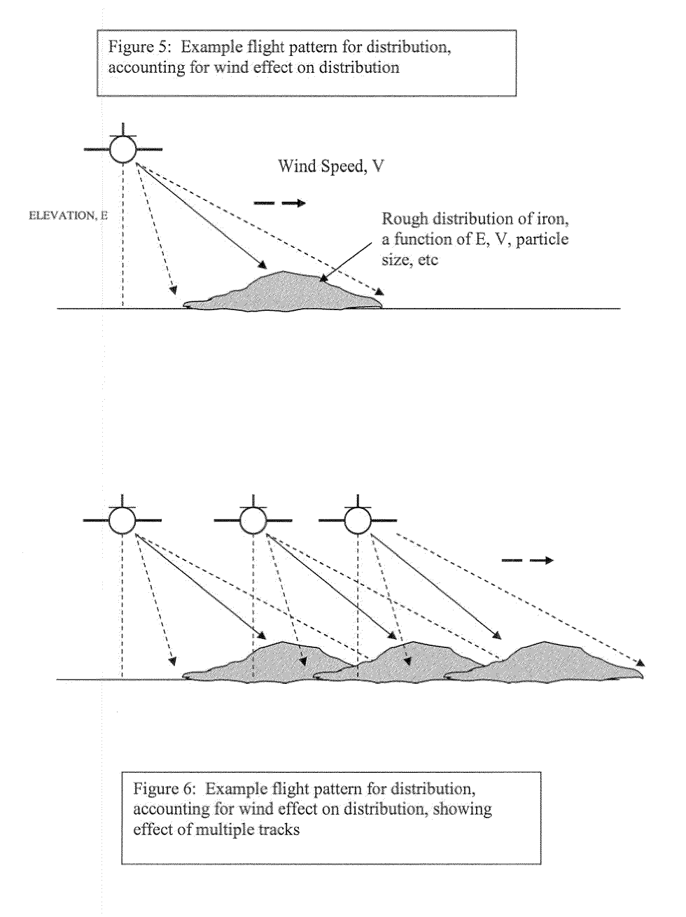

The optimum pattern (see FIGS. 1-4) may involve flying dispersal paths roughly perpendicular to the prevailing winds, and overlapping the pattern to allow for the uncertainty of the actual precipitation on the ocean surface. Because of the need for validation of the seeding effectiveness, the edges of the seeded pattern on the ocean surface are especially important. The pattern flown may be optimized to include passes over the target area of varying elevations, especially with lower elevations at the edges of the pattern, and higher elevations over the mid portions of the pattern.

It may be necessary to provide data and evidence of successful application of fertilizer, the biological response and the sequestration result can be presented to the appropriate agency, and credits successfully obtained. That the application of the iron was conducted according to plan may be validated with the data from the on-board device, and by data from other methods that are generally well understood, including methods of measuring the degree of plankton bloom. The result of the seeding effort is a report that allows acquisition of carbon credits, and payments therefore.

“Currently there are five exchanges trading in carbon allowances: the Chicago Climate Exchange, European Climate Exchange, Nord Pool, PowerNext and the European Energy Exchange. Recently, NordPool listed a contract to trade offsets generated by a CDM carbon project called Certified Emission Reductions (CERs). Many companies now engage in emissions abatement, offsetting, and sequestration programs to generate credits that can be sold on one of the exchanges. At least one private electronic market has been established in 2008: CantorCO2e.” (ref 14).

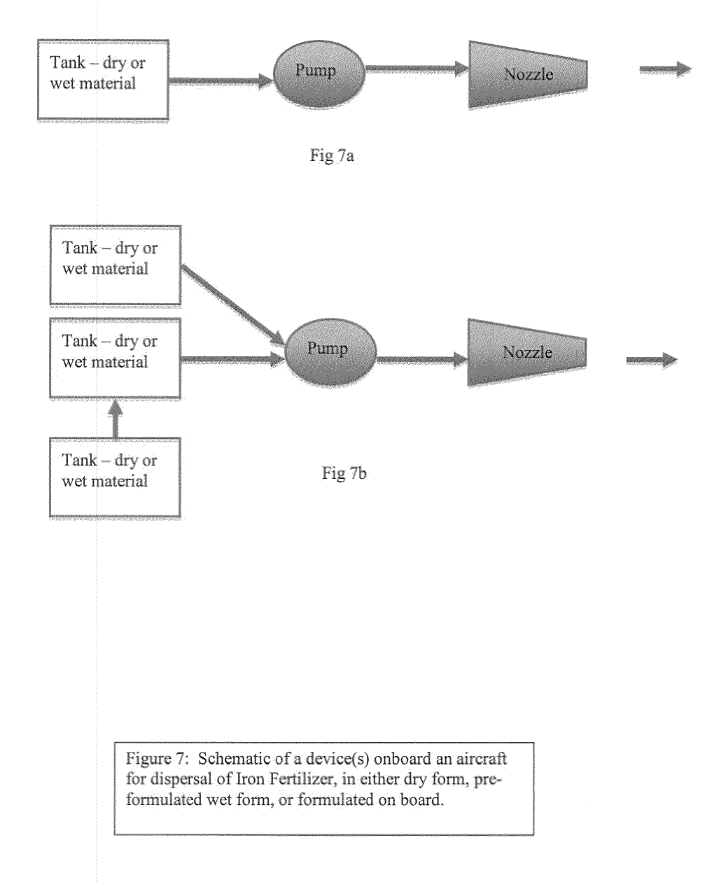

In FIG. 7a, the aircraft is shown in section with apparatus for dispersing an essentially dry fertilizer such as iron in an MOF form, or a pre-mixed wet fertilizer. The apparatus can be obtained by purchase of standard parts, and arranged in a manner that the flow rate of the material through the dispersing nozzle is accurately controlled and measured. In FIG. 7b, the aircraft is shown with multiple tanks, as would be needed for dispersal of a wet fertilizer that is formulated on board the aircraft.

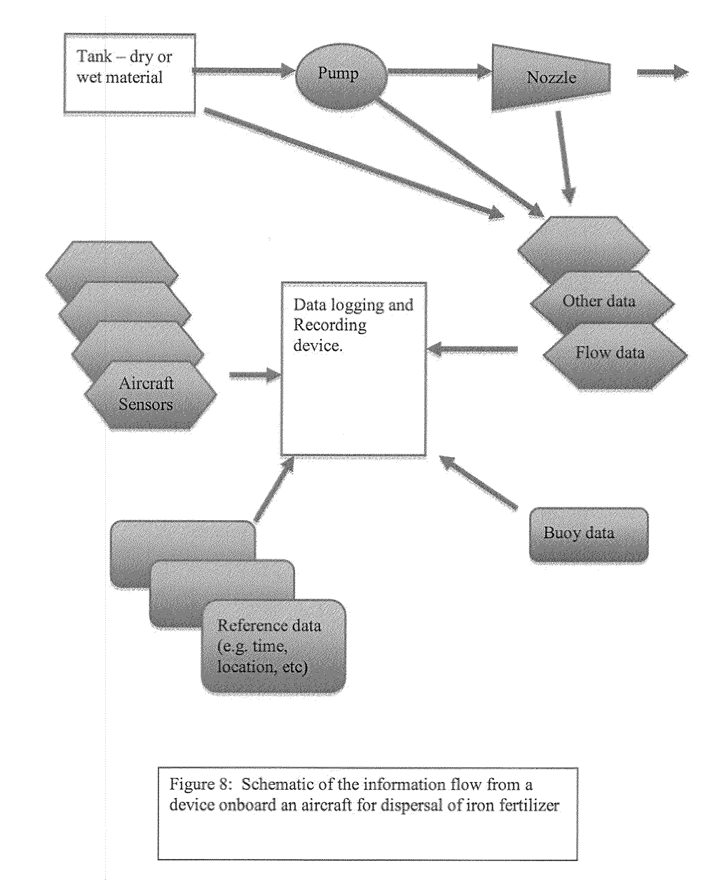

In FIG. 8, the aircraft includes an apparatus for dispersing the fertilizer from the aircraft, an apparatus for monitoring the dispersal of the fertilizer to a body of water, and an apparatus for verifying that the fertilizer has been applied to a body of water. Appropriate devices for this purpose can be obtained by purchase of standard parts, and arranged in a manner that the flow rate of the material through the dispersing nozzle is accurately controlled and measured, and the information on the position, elevation and speed of the aircraft is simultaneously collected, and information on the relative position of the aircraft and the fertilized area of the ocean is also collected. In addition, other data, such as local wind speed and direction, current speed and direction may also be collected to assist in the documentation and validation of the fertilization activity.

A number of embodiments of the invention have been described. Nevertheless, it will be understood that various modifications may be made without departing from the spirit and scope of the invention. For example, the form of payment for the sequestration may take many forms, including checks, cash, or electronic payments. Payments may be made in a variety of countries, and may be both direct payments from a market, or a tax credit in some form (refs 14-20). There are many variations of the patterns that may be flown to accomplish the desired results, including spiral patterns, overlapping circles, etc.

Accordingly, other embodiments are within the scope of the following claims.

What is claimed is:

1. A method of acquiring a monetizable credit for sequestration of carbon from an agency authorized to issue the credit for distributing a plankton-growth fertilizer to a body of water from an airborne craft, the plankton growth fertilizer including iron, the method including,
providing evidence to the agency of successful fertilization and carbon sequestration by delivery of the fertilizer to a body of water from the air, the evidence including data indicative of fertilizer distribution by air and data indicative of an increase in plankton in the region of the distribution, and
obtaining credit for carbon sequestration.

2. The method of claim 1 which further comprises:
outfitting an aircraft from which to distribute a plankton-growth fertilizer by providing on the aircraft:
a dry composition that is, or can be used to make, a fertilizer for application to a body of water, the composition including iron in a form that is, or can be converted into, a biologically useful form usable for fertilization,
an apparatus for dispersing the fertilizer from the aircraft,
an apparatus for monitoring the dispersal of the fertilizer to a body of water, and
an apparatus for verifying that the fertilizer has been applied to a body of water; and
providing to the agency data obtained from the apparatus for verifying that the fertilizer has been applied.

3. The method of outfitting an aircraft to distribute a plankton-growth fertilizer, by providing on the aircraft:
a composition that is, or can be used to make, a fertilizer for application to a body of water, the composition including iron in a form that is, or can be converted into, a biologically useful form usable for fertilization,
an apparatus for monitoring the dispersal of the fertilizer to a body of water, and
an apparatus for verifying that the fertilizer has been applied to a body of water.

4. The method of claim 2 where the fertilizer comprises chelated iron sulfate.

5. The method of claim 2 where the fertilizer comprises iron in a Metal Organic Framework.

6. The method of claim 1 where an apparatus for monitoring dispersion of the fertilizer from the air collects and stores dispersion data, the dispersion data including distribution rate of the fertilizer, aircraft location, aircraft elevation, and aircraft speed.

7. The method of claim 6 comprising presenting the dispersion data to the agency to validate that the application of fertilizer took place in a manner approved by the agency.

8. The method of claim 6 where the apparatus for monitoring dispersal, the apparatus for dispersing and the apparatus for verifying dispersal are present as one, two or three separate devices.

9. The method of claim 2 where the aircraft includes apparatus for collecting data representing local wind and local water current.

10. The method of claim 2 where the apparatus for verifying application of fertilizer includes apparatus to receive signals from buoys that indicate the presence of iron or trace elements distributed on the ocean surface.

11. The method of claim 2 where the apparatus for monitoring the dispersal of fertilizer includes apparatus for receiving and processing signals from buoys floating with currents, the buoys communicating their location on the surface water, and providing a signal for adjusting one or more of aircraft course, speed, or altitude for optimum fertilizer dispersal in the presence of a current.

12. The method of claim 2 in which the aircraft is provided with means to control the aircraft to disperse the fertilizer in a controlled pattern designed for uniformity of distribution of the iron fertilizer on the surface of the ocean.

13. The method of claim 12 where the pattern oriented roughly perpendicular to the local wind direction.

14. The method of claim 12 where the pattern includes dispersal as the aircraft is flown at varying elevations.

15. The method of claim 14 in which the pattern includes dispersal at lower elevations at the edges of the pattern, for ease of validation of the plankton bloom.

16. The method of claim 12 where the pattern of dispersal is includes overlapping tracks.

17. The method of claim 1 where the credit for carbon sequestration is payment from a registered carbon trading market.

18. The method of claim 1 where the credit is a direct payment for services, and the agency is a governmental agency or a corporate entity.

19. The method of claim 1 where the credit is an authorization for a tax benefit from a governmental agency or taxing authority.

20. The method of claim 1 where the credit is an authorization to emit carbon dioxide to the atmosphere.

21. The method of claim 17 where the credit is in the form of an electronic payment.
